(19) United States
(12) Patent Application Publication
(10) Pub. No.: US 2013/0342034 A1
(43) Pub. Date: Dec. 26, 2013

(54) LINEAR VIBRATOR

(71) Applicants: Dong Su MOON, Suwon (KR); Kyung Su Park, Suwon (KR); Yong Tae Kim, Suwon (KR)

(72) Inventors: Dong Su MOON, Suwon (KR); Kyung Su Park, Suwon (KR); Yong Tae Kim, Suwon (KR)

(73) Assignee: SAMSUNG ELECTRO-MECHANICS CO., LTD.

(21) Appl. No.: 13/599,481

(22) Filed: Aug. 30, 2012

(30) Foreign Application Priority Data
Jun. 26, 2012 (KR) 10-2012-0068674

(51) Int. Cl. H02K 33/00

(52) U.S. Cl. 310/25

(57) ABSTRACT

There is provided a linear vibrator including: a fixed part including a case open at one side thereof and providing an internal space therein and a bracket coupled to the case; a vibrating part disposed in the internal space and including a magnet having a hollow part and a mass body coupled to an outer peripheral surface of the magnet; an elastic member having one end coupled to the vibrating part and the other end coupled to the fixed part; a shaft having upper and lower portions fixed to one surface of the case and the bracket, respectively, and penetrating through the hollow part of the magnet; a coil provided on an outer peripheral surface of the shaft and generating electromagnetic force; and a bush disposed on the coil and concentrating the electromagnetic force generated therein in a single direction.

### CROSS-REFERENCE TO RELATED APPLICATIONS

This application claims the priority of Korean Patent Application No. 10-2012-0068674 filed on Jun. 26, 2012, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator capable of being mounted in a portable electronic device and being applied to a silent call reception signal generating device.

2. Description of the Related Art

Recently, as the release of personal digital assistants having large liquid crystal display (LCD) screens for user convenience onto the market has rapidly increased, a touch screen scheme has been adopted, and a vibration motor for generating vibrations at the time of a touch has been used therewith.

The vibration motor, a component converting electric energy into mechanical vibrations using the principle of generating electromagnetic force, is mounted in a personal digital assistant to thereby be used for silently notifying a user of call reception by transferring vibrations thereto.

According to the related art, a scheme of obtaining mechanical vibrations by generating rotational force to rotate a rotor part having unbalanced mass has been used. In this scheme, the rotational force is converted into the mechanical vibration by a rectifying action through a contact point between a brush and a commutator.

However, in a brush type structure using the commutator, since the brush passes through a clearance between segments of the commutator at the time of motor rotation, mechanical friction and electrical sparks may be caused and foreign objects may be generated, such that a lifespan of the motor may be reduced.

In addition, since it takes a time to arrive at a target amount of vibrations, due to rotational inertia at the time of the application of voltage to the motor, there is a problem in implementing an appropriate amount of vibrations in a touch screen.

A linear vibrator has mainly been used in order to improve a defect with respect to a lifespan and response characteristics of the motor and to implement a vibration function in a touch screen.

The linear vibrator does not use the rotation principle of the motor, but uses the principle that electromagnetic force obtained through a spring installed therein and a mass body suspended from the spring is periodically generated according to a resonance frequency to cause resonance, thereby generating vibrations.

In accordance with the market trend for the miniaturization and slimming of portable electronic devices, this linear vibrator should be able to be slimed and efficiently produced, and performance and characteristics of the linear vibrator should not be affected, even in the case in which several factors act in concert.

However, in the linear vibrator according to the related art, noise may be generated due to interference between components. This phenomenon may also have an influence on the performance and characteristics of the linear vibrator.

The following Related Art Document (Patent Document) discloses a linear vibrator in which a vibration part is inserted into a support shaft supported by upper and lower plates of a case and is supported by the support shaft.

### RELATED ART DOCUMENT

(Patent Document 1) Korean Patent Laid-open Publication No. 2008-0074329

### SUMMARY OF THE INVENTION

An aspect of the present invention provides a linear vibrator capable of securing reliability against falling due to an external impact or the like by preventing components configuring the linear vibrator from being separated or shaken due to an external impact, or the like.

According to an aspect of the present invention, there is provided a linear vibrator including: a fixed part including a case open at one side thereof and providing an internal space therein and a bracket coupled to the case; a vibrating part disposed in the internal space and including a magnet having a hollow part and a mass body coupled to an outer peripheral surface of the magnet; an elastic member having one end coupled to the vibrating part and the other end coupled to the fixed part; a shaft having upper and lower portions fixed to one surface of the case and the bracket, respectively, and penetrating through the hollow part of the magnet; a coil provided on an outer peripheral surface of the shaft and generating electromagnetic force; and a bush disposed on the coil and concentrating the electromagnetic force generated therein in a single direction.

The vibrating part may further include a yoke plate fixing the magnet and concentrating magnetic force of the magnet in a single direction.

The yoke plate may include an upper yoke plate coupled to an upper portion of the magnet and a lower yoke plate coupled to a lower portion of the magnet.

The lower yoke plate may have a diameter larger than that of the upper yoke plate.

The bush may have a diameter larger than that of the coil and smaller than an inner diameter of the magnet.

The linear vibrator may further include a damper provided on an inner surface of the fixed part in order to prevent contact noise due to the vibrating part vibrating.

The case may include an outer wall formed on one inner surface thereof in order to fix the upper portion of the shaft.

The bracket may include a protrusion hole formed on an inner surface thereof in order to fix the lower portion of the shaft.

The shaft may have a cylindrical shape.

The linear vibrator may further include a magnetic fluid applied to an inner peripheral surface of the magnet.

The bush may be formed of a ferromagnetic material.

According to another aspect of the present invention, there is provided a linear vibrator including: a fixed part including a case and a bracket coupled to the case; a shaft having upper and lower portions fixed to one surface of the case and the bracket, respectively; a magnet provided on an outer peripheral surface of the shaft; a bush disposed on the magnet and concentrating magnetic force of the magnet in a single direction; a vibrating part including a coil disposed to face the bush and a mass body coupled to an outer peripheral surface of the coil; and an elastic member having one end coupled to the vibrating part and the other end coupled to the fixed part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a linear vibrator according to an embodiment of the present invention;

FIG. 2 is a schematic exploded perspective view showing the linear vibrator according to the embodiment of the present invention;

FIG. 3 is an assembled perspective view of a shaft, a bush, a coil and a bracket of the linear vibrator according to the embodiment of the present invention; and

FIG. 4 is a schematic cross-sectional view showing a linear vibrator according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

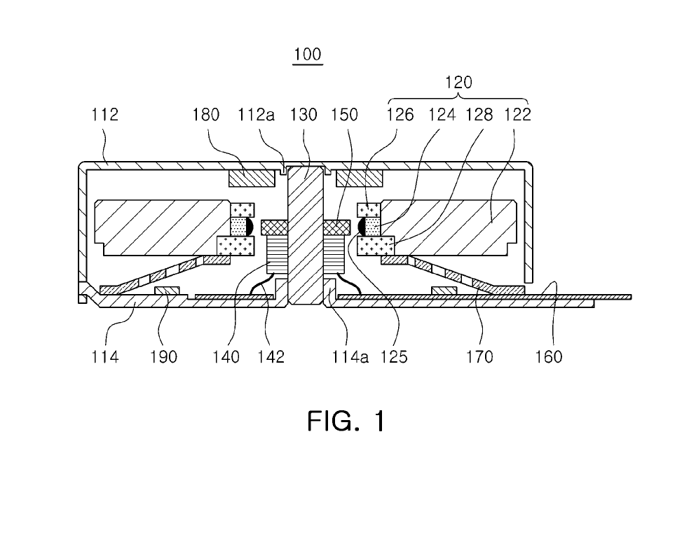

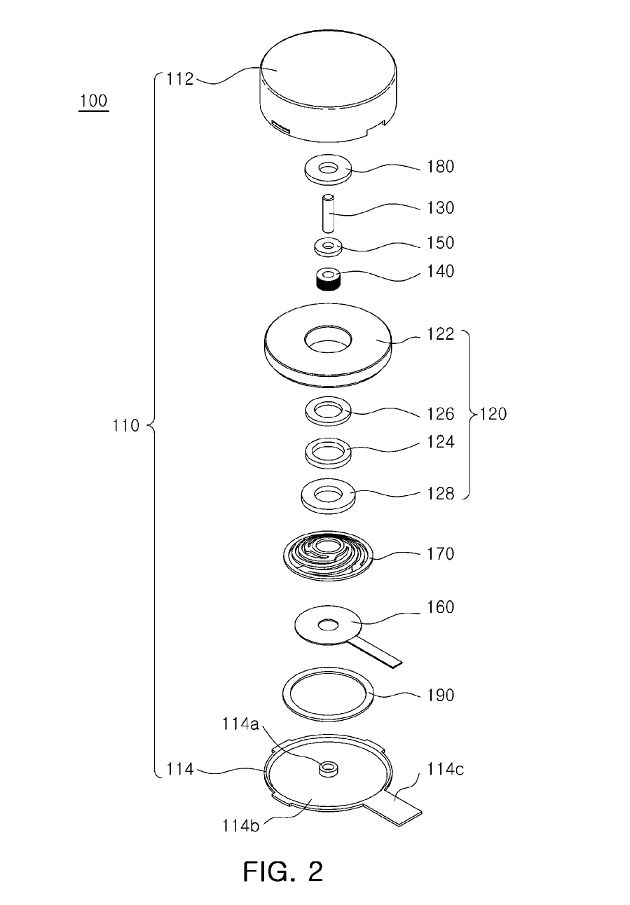

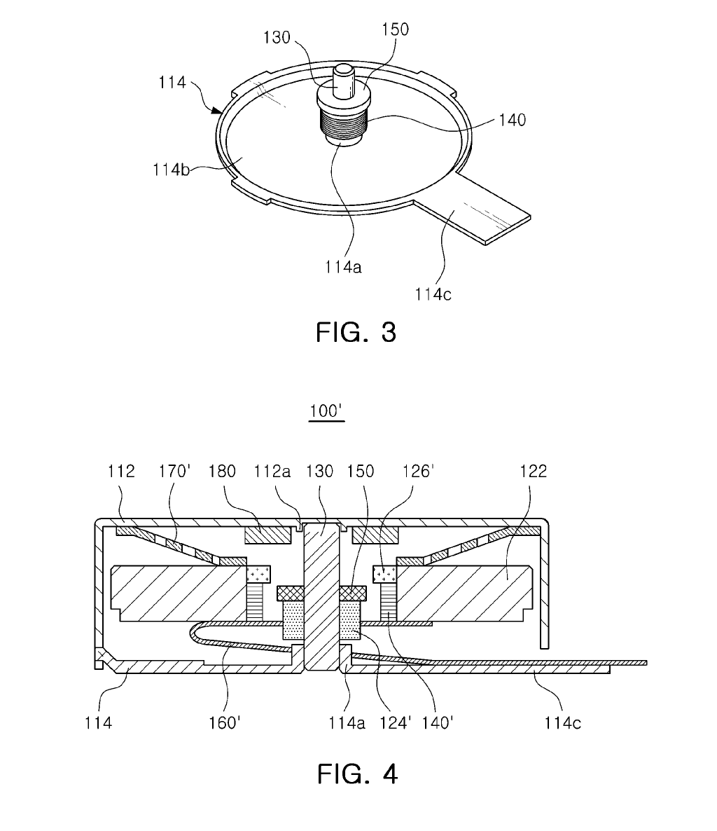

FIG. 1 is a schematic cross-sectional view showing a linear vibrator according to an embodiment of the present invention; FIG. 2 is a schematic exploded perspective view showing the linear vibrator according to the embodiment of the present invention; and FIG. 3 is an assembled perspective view of a shaft, a bush, a coil and a bracket of the linear vibrator according to the embodiment of the present invention.

Terms with respect to directions will first be defined. An outer diameter or inner diameter direction refers to a direction from the center of a case 112 toward an outer peripheral surface of the case 112 or a direction opposite thereto, and an upward or downward direction refers to a direction from a bracket toward the top of the case or a direction opposite thereto.

Referring to FIGS. 1 through 3, the linear vibrator 100 according to the embodiment of the present invention may include a fixed part 110 forming a body of the linear vibrator 100, a vibrating part 120 including a magnet 124 and a mass body 122, an elastic member 170, a shaft 130 having upper and lower portions fixed to one surface of the case 112 and the bracket 114, respectively, a coil 140 provided on an outer peripheral surface of the shaft 130, and a bush 150 disposed on the coil 140.

The fixed part 110 may include the case 112 open at one side thereof and providing a predetermined internal space therein, and the bracket 114 coupled to the open side of the case 112 to close the internal space formed by the case 112.

Here, the internal space may accommodate the vibrating part 120 including the magnet 124 and the mass body 122 therein, and the case 112 and the bracket 114 may also be formed integrally with each other.

Here, the bracket 114 may include a closing part 114b closing the open side of the case 112 and a protrusion part 114c protruding outwardly of the case 112 after the bracket 114 is coupled to the case 112.

The vibrating part 120 may include the magnet 124 having a hollow part, yoke plates 126 and 128, and the mass body 122, and vibration may be transferred through the medium of the elastic member 170.

That is, the vibrating part 120 may be a member capable of being vertically vibrated through the medium of the elastic member 170.

Here, the magnet 124 may have an inner diameter larger than outer diameters of a coil 140 and a bush 150 to be described below.

More specifically, the magnet 124 may be disposed to face the bush 150, and the magnet 122 and the bush 150 may have a predetermined clearance formed therebetween.

Therefore, during an operation of the vibrating part 120, the coil 140 and the bush 150, and the magnet 124 may be maintained in a state in which they do not contact each other.

Here, the magnet 124 may have upper and lower yoke plates 126 and 128 coupled to upper and lower portions thereof, respectively.

The upper and lower yoke plates 126 and 128 may support the upper and lower portions of the magnet 124, respectively, to allow the magnet 124 to be more firmly coupled to the mass body 122.

In addition, the upper and lower yoke plates 126 and 128 may concentrate magnetic force of the magnet 124 in a single direction to increase an amount of vibrations of the vibrating part 120.

Here, the lower yoke plate 128 may have a diameter larger than that of the upper yoke plate 126.

To this end, a portion of an inner peripheral surface of the mass body 122 coupled to the lower yoke plate 128 may be stepped in the outer diameter direction, and a portion of the lower yoke plate 128 may be accommodated in the stepped portion of the mass body 122.

The upper and lower yoke plates 126 and 128 may be formed of a magnetic material, which may allow a magnetic fluid 125 to be smoothly applied.

That is, an inner peripheral surface of the magnet 124 and a bush 150 to be described below may have the magnetic fluid 125 applied therebetween, wherein the magnetic fluid 125 may serve to prevent abnormal vibrations when the vibrating part 120 vibrates.

In other words, the magnetic fluid 125 may be disposed in a clearance formed between the magnet 124 and the bush 150 so as to allow the vibrating part 120 to be smoothly vertically vibrate and may prevent abnormal vibrations generated due to a horizontal or vertical shake of the vibrating part 120 caused by an external impact, or the like.

The magnetic fluid 125 may be a material having a property that it is collected in the magnetic flux of the magnet 124. In the case in which the magnetic fluid 125 is applied to one surface of the magnet 124, it is collected at a magnetic flux generation point of the magnet 124 to have an annular shape.

Here, the magnetic fluid 125 may be prepared by dispersing magnetic powder particles in liquid in a colloid shape and then adding a surfactant thereto so that precipitation or aggregation of the magnetic powder particles due to gravity, a magnetic field, or the like, does not occur. As an example of the magnetic fluid 125, a tri-iron tetra-oxide and a material prepared by dispersing iron-cobalt alloy particles in oil or water may be used. Recently, a material prepared by dispersing cobalt in toluene is used.

These magnetic powder particles may be ultrafine powder particles and conduct the Brownian motion unique to an ultrafine particle, such that even in the case in which an external magnetic field, gravity, centrifugal force, or the like, is applied thereto, a concentration of magnetic powder particles in a fluid is maintained to be constant.

In addition, the magnetic fluid 125 may be filled in a gap between the inner peripheral surface of the magnet 124 and an outer peripheral surface of the bush 150 to allow the vibrating part 120 to be smoothly vibrated and slid.

The mass body 122 may be coupled to an outer peripheral surface of the magnet 124 by at least one of a bonding method, a press-fitting method, and a welding method.

In the case in which the mass body 122 is vertically vibrated, the mass body 122 may have an outer diameter smaller than an inner diameter of an inner peripheral surface of the case 112 so that it may be vibrated in the fixed part 110 without a contact.

Therefore, a clearance having a predetermined size may be formed between the inner peripheral surface of the case 112 and an outer peripheral surface of the mass body 122.

This mass body 122 may be formed of a non-magnetic material or a paramagnetic material that is not affected by the magnetic force generated from the magnet 124.

Therefore, the mass body 122 may be formed of a material such as tungsten having specific gravity higher than that of iron, which is to increase mass of the vibrating part 120 in the same volume to adjust a resonance frequency, thereby significantly increasing an amount of vibrations.

However, the mass body 122 is not limited to being formed of tungsten, but may also be formed of various materials according to the designer's intention.

The shaft 130 may have the upper and lower portions fixed to one inner surface of the case 112 and the bracket 114, respectively, and penetrate through the hollow part of the magnet 124.

The shaft 130 may have a cylindrical shape, but is not limited thereto.

The case 112 may include an outer wall 112a protruding from the inner surface thereof so as to correspond to an outer diameter of the shaft 130. Therefore, an outer peripheral surface of an upper portion of the shaft 130 may be inserted into and fixed to an inner peripheral surface of the outer wall 112a to more firmly couple the shaft 130 to the inner surface of the case 112.

In addition, the bracket 114 may include a protrusion hole 114a formed on an inner surface thereof, wherein the protrusion hole 114a penetrates through the bracket 114 and is bent upwardly.

An inner diameter of the protrusion hole 114a may correspond to the outer diameter of the shaft 130, and an outer peripheral surface of a lower portion of the shaft 130 may be inserted into and fixed to an inner peripheral surface of the protrusion hole 114a to firmly couple the shaft 130 to the bracket 114.

The shaft 130 is firmly fixed to the case 112 and the bracket 114, whereby the shaft 130 may serve to support the fixed part 110 including the case 112 and the bracket 114. Therefore, even in the case that external impact, or the like, is applied to the case 112 and the bracket 114, distortion or warpage of the case 112 and the bracket 114 may be prevented.

Here, the shaft 130 may include the coil 140 provided on the outer peripheral surface thereof in order to generate electromagnetic force.

The coil 140 may interact with the magnet 124 to generate the electromagnetic force, which allows the vibrating part 120 to be vertically vibrated.

A lead wire 142 of the coil 140 may be electrically connected to a substrate 160 to be described below to apply power to the coil 140.

Here, when current is applied to the coil 140 according to a predetermined frequency, a magnetic field may be induced around the coil 140.

In this case, when electromagnetic force is excited in the coil 140, a magnetic flux may pass from the magnet 124 through the coil 140 in a horizontal direction, and a magnetic field may be generated in a vertical direction by the coil 140, such that the vibrating part 120 vibrates in the vertical direction.

Therefore, a magnetic flux direction of the magnet 124 and a vibration direction of the vibrating part 120 may become perpendicular to each other.

That is, when electromagnetic force having the same frequency as a mechanical natural frequency of the vibrating part 120 is excited, resonance vibrations are generated in the vibrating part 120, such that a relative maximum amount of vibrations may be obtained, wherein the natural frequency of the vibrating part 120 is affected by the mass of the vibrating part 120 and an elastic modulus of the elastic member 170.

Here, the current applied to the coil 140, that is, external power having a predetermined frequency may be provided by the substrate 160 coupled to the vibrating part 120, more specifically, by a power connection terminal (not shown) of the substrate 160.

The coil 140 may include the bush 150 disposed thereon, wherein the bush 150 may be disposed to face the magnet 124.

The bush 150 may concentrate the electromagnetic force generated from the coil 140 in a single direction, and the vibrating part 120 may be vertically vibrated by the magnetic force of the magnet 124 and attractive force and repulsive force of the electromagnetic force.

Here, the bush 150 may be formed of a ferromagnetic material, which is to concentrate the electromagnetic force generated from the coil to obtain a relatively large vibration amount.

Each of the coil 140 and the bush 150 may have an inner diameter corresponding to the outer diameter of the shaft 130 and be coupled to and disposed on the outer peripheral surface of the shaft 130.

In addition, the bush 150 may have an outer diameter larger than that of the coil 140. Therefore, in the case in which an external impact, or the like occurs, contact between the magnet 124 or the yoke plates 126 and 128 and the coil 140 due to the horizontal movement of the vibrating part 120 may be prevented.

The elastic member 170 may have one end coupled to the vibrating part 120 and the other end coupled to the fixed part 110 to provide elastic force to the vibrating part 120. The elastic modulus of the elastic member 170 may affect the natural frequency of the vibrating part 120.

More specifically, one end of the elastic member 170 may be coupled to a portion of a lower surface of each of the mass body 122 and the lower yoke plate 128 configuring the vibrating part 120, and the other end thereof may be coupled to the fixed part 110.

Here, the elastic member 170 may be any one of a coil spring and a leaf spring. However, the elastic member 170 is not limited thereto, but may be any member capable of providing the elastic force.

The substrate 160 may be coupled to one surface of each of the mass body 122 and the lower yoke plate 128 configuring the vibrating part 120 and have a through-hole formed therein so that the shaft 130 and the protrusion hole 114a of the bracket 114 penetrate therethrough.

In addition, the substrate 160 may include an electrode pad (not shown) provided in order to transfer an electrical signal having a specific frequency to the coil 140, wherein the electrode pad (not shown) may be electrically connected to the lead wire 142 of the coil 140.

Therefore, the lead wire of the coil 140 may be coupled to the electrode pad (not shown) of the substrate 160 at an outer side of the coil 140, such that it does not affect vibration and movement of the linear vibrator 100 according to the embodiment of the present invention in the case in which the linear vibrator 100 operates.

Dampers 180 and 190 may be disposed on at least one of the inner surface of the case 112 and the inner surface of the bracket 114.

The dampers 180 and 190 may be members for preventing noise from being generated due to contact between the vibrating part 120 and the case 112 or the bracket 114 when the vibrating part 120 is vertically vibrated.

FIG. 4 is a schematic cross-sectional view showing a linear vibrator according to another embodiment of the present invention.

Referring to FIG. 4, the linear vibrator 100′ according to another embodiment of the present invention has the same configuration as that of the linear vibrator 100 described above with reference to FIGS. 1 through 3 except for a magnet, a coil, a yoke plate, an elastic member, and a substrate. Therefore, a description of components other than the magnet, the coil, the yoke plate, the elastic member, and the substrate will be omitted.

In the linear vibrator 100′ according to another embodiment of the present invention, a shaft 130 may include a magnet 124′ provided on an outer peripheral surface thereof, and a mass body 122 may include a coil 140′ coupled to an inner peripheral surface thereof.

That is, in the linear vibrator 100′ according to another embodiment of the present invention, positions of the magnet and the coil among the components of the linear vibrator 100 described above with reference to FIGS. 1 through 3 may be exchanged with each other.

The magnet 124′ may be disposed on the outer peripheral surface of the shaft 130 and include a bush 150 disposed thereon.

The mass body 122 may be coupled to an outer peripheral surface of the coil 140′ by at least one of a bonding method, a press-fitting method, and a welding method, and the coil 140′ may have a yoke plate 126′ provided thereon.

An elastic member 170′ may have one end coupled to a portion of an upper surface of each of the mass body 122 and the yoke plate 126′ configuring the vibrating part and the other end coupled to the fixed part 110.

The substrate 160′ may be a flexible printed circuit board, be coupled to a lower surface of the mass body 122 configuring the vibrating part, and have a through-hole through which the magnet 124′ is passed so as not to contact the magnet 124′ at the time of the vibrating part vibrating.

That is, the through-hole may prevent contact between the magnet 124′ and the substrate 160′ and allow an amplitude not to be limited at the time of the vibration and the movement of the vibrating part to secure an amount of vibrations of the vibrating part as much as possible.

Therefore, the linear vibrator 100′ according to another embodiment of the present invention may obtain more stable linear vibrations through the through-hole.

More specifically, one end of the substrate 160′ may be coupled to the vibrating part to thereby become a free end, and the other end thereof may be coupled to a protrusion part 114c of the bracket 114 to thereby become a fixed end.

In addition, the substrate 160′ may include an electrode pad (not shown) provided on a lower surface thereof in order to transfer an electrical signal having a specific frequency to the coil 140′, wherein the electrode pad (not shown) may be electrically connected to a lead wire of the coil 140′.

Here, the electrode pad (not shown) may be formed at an outer side of an outer diameter of the coil 140′ and may be electrically connected to one end of the lead wire of the coil 140′ by soldering.

Therefore, the lead wire of the coil 140′ may be coupled to the electrode pad (not shown) of the substrate 160′ at an outer side of the coil 140′, such that it does not affect vibration and movement of the linear vibrator 100′ according to the embodiment of the present invention in the case in which the linear vibrator 100′ operates.

According to the embodiments of the present invention described above, at the time of the vibrating part 120 vibrating or even in the case that the external impact, or the like, occurs, the shaft 130 supports the case 112 and the bracket 114 that configure the fixed part 110, whereby damage of appearances of the case 112 and the bracket 114 may be prevented. In addition, the coil 140 and the bush 150 are coupled to the outer peripheral surface of the shaft 130 firmly coupled to the fixed part 110, such that the coil 140 and the bush 150 are not also affected by the external impact, or the like, whereby reliability of the linear vibrator 100 against falling may be secured.

In addition, since the shaft 130 has strength larger than that of the bracket 114, a residue that may be generated at the time of insertion of the shaft 130 is generated at an outer side of the bracket, whereby disconnection of the lead wire 142 of the coil 140 may be prevented.

Further, the shaft 130 and the bush 150 that are easily and simply manufactured are used, whereby a material cost may be reduced.

As set forth above, with the linear vibrator according to the embodiments of the present invention, even in the case that the external impact, or the like, occurs, the separation or the shake of the components configuring the linear vibrator may be prevented, the distortion or the warpage of the case or the bracket may be prevented, and the material cost may be reduced.

While the present invention has been shown and described in connection with the embodiments, it will be apparent to those skilled in the art that modifications and variations can be made without departing from the spirit and scope of the invention as defined by the appended claims.

What is claimed is:

1. A linear vibrator comprising:
a fixed part including a case open at one side thereof and providing an internal space therein and a bracket coupled to the case;
a vibrating part disposed in the internal space and including a magnet having a hollow part and a mass body coupled to an outer peripheral surface of the magnet;
an elastic member having one end coupled to the vibrating part and the other end coupled to the fixed part;
a shaft having upper and lower portions fixed to one surface of the case and the bracket, respectively, and penetrating through the hollow part of the magnet;
a coil provided on an outer peripheral surface of the shaft and generating electromagnetic force; and
a bush disposed on the coil and concentrating the electromagnetic force generated therein in a single direction.

2. The linear vibrator of claim 1, wherein the vibrating part further includes a yoke plate fixing the magnet and concentrating magnetic force of the magnet in a single direction.

3. The linear vibrator of claim 2, wherein the yoke plate includes an upper yoke plate coupled to an upper portion of the magnet and a lower yoke plate coupled to a lower portion of the magnet.

4. The linear vibrator of claim 3, wherein the lower yoke plate has a diameter larger than that of the upper yoke plate.

5. The linear vibrator of claim 1, wherein the bush has a diameter larger than that of the coil and smaller than an inner diameter of the magnet.

6. The linear vibrator of claim 1, further comprising a damper provided on an inner surface of the fixed part in order to prevent contact noise due to the vibrating part vibrating.

7. The linear vibrator of claim 1, wherein the case includes an outer wall formed on one inner surface thereof in order to fix the upper portion of the shaft.

8. The linear vibrator of claim 1, wherein the bracket includes a protrusion hole formed on an inner surface thereof in order to fix the lower portion of the shaft.

9. The linear vibrator of claim 1, wherein the shaft has a cylindrical shape.

10. The linear vibrator of claim 1, further comprising a magnetic fluid applied to an inner peripheral surface of the magnet.

11. The linear vibrator of claim 1, wherein the bush is formed of a ferromagnetic material.

12. A linear vibrator comprising:
a fixed part including a case and a bracket coupled to the case;
a shaft having upper and lower portions fixed to one surface of the case and the bracket, respectively;
a magnet provided on an outer peripheral surface of the shaft;
a bush disposed on the magnet and concentrating magnetic force of the magnet in a single direction;
a vibrating part including a coil disposed to face the bush and a mass body coupled to an outer peripheral surface of the coil; and
an elastic member having one end coupled to the vibrating part and the other end coupled to the fixed part.
